(19) United States
(12) Patent Application Publication
(10) Pub. No.: US 2020/0266594 A1
(43) Pub. Date: Aug. 20, 2020

(54) EXTENSION BASE WITH CABLE AND FLAT CABLE

(71) Applicant: LUXSHARE-ICT CO., LTD., Taipei City (TW)

(72) Inventors: Chang-Sing Chu, Taipei City (TW); Gang Hu, Taipei City (TW)

(73) Assignee: LUXSHARE-ICT CO., LTD., Taipei City (TW)

(21) Appl. No.: 16/868,818

(22) Filed: May 7, 2020

(30) Foreign Application Priority Data
Dec. 26, 2019 (CN) 201911366567.X
Dec. 26, 2019 (CN) 201922387236.6

(51) Int. Cl. H01R 31/00; H01R 13/66; H01R 13/646

(52) U.S. Cl. CPC H01R 31/005; H01R 13/646; H01R 13/665

(57) ABSTRACT

An extension base with flat cable includes a base body, a flat cable, and a connector. The base body includes a shell, a control circuit, and one or more connecting port. The control circuit is inside the shell. The connecting port is coupled to the control circuit and disposed on an outer wall of the shell. The flat cable includes a plurality of coaxial cables and a soft-insulated cover. The coaxial cables extend in a first direction and are parallel in a second direction. The first direction is perpendicular to the second direction. One of two ends of each of the coaxial cables is coupled to the control circuit. The soft-insulated cover covers peripheries of the coaxial cables arranged parallel. The connector is coupled to the other end of each of the coaxial cables.

### CROSS-REFERENCES TO RELATED APPLICATIONS

This non-provisional application claims priority under 35 U.S.C. § 119(a) to Patent Application No. 201911366567.X and 201922387236.6, filed in China, P.R.C. on Dec. 26, 2019, the entire contents of which are hereby incorporated by reference.

### BACKGROUND

### Technical Field

The instant disclosure relates to an extension base and a flat cable, in particular, to an extension base with the flat cable and the flat cable.

### Related Art

Cables are often used for the electrical connection between two electronic components and are an essential connecting member in the electronics industries. Moreover, cables are mostly used for signal transmissions of various electronic products, and they have the advantages of arbitrary bending and high speed signal transmission. In addition, a cable can be used with a connector or coupled with a control circuit to transmit a signal from one end of the cable to the other so as to achieve the purpose of signal transmission.

Commonly, an electronic device with a cable may be an extension base. Taking the extension base as an example, the cross sections of the cables connected to the extension bases known to the inventor are often circular. Also, the wires in the cables are mostly arranged in an annular manner. That is, a wire is arranged at the center of the cable, and the remaining wires are arranged annularly along the periphery of the wire at the center.

In addition, in response to nowadays consumer's demands for portability, the appearances of various types of extension bases have also become thinner and lighter.

### SUMMARY

As a result, there are also the same demands for cables connected to extension bases. However, the assembly way of wires in the cables is not beneficial to the development of thinner trend of the extension bases, and limits the appearance of the extension base. Therefore, an extension bases with a flat cable and the flat cable are provided in the instant disclosure. By designing the cable of the extension base into a flat shape, the overall appearance of the extension base tends to be thinner.

In one of embodiments, an extension base with flat cable includes a base body, a flat cable, and a connector. The base body includes a shell, a control circuit, and at least one connecting port. The control circuit is inside the shell. The at least one connecting port is coupled to the control circuit and disposed on an outer wall of the shell. The flat cable includes a plurality of coaxial cables and a soft-insulated cover. The coaxial cables extend in a first direction and are arranged parallel in a second direction. The first direction is perpendicular to the second direction. One of two ends of each of the coaxial cables is coupled to the control circuit. The soft-insulated cover covers peripheries of the coaxial cables arranged parallel. The connector is coupled to the other end of each of the coaxial cables.

In one of embodiments, a flat cable includes a plurality of coaxial cables and a soft-insulated cover. The coaxial cables extend in a first direction and are arranged parallel in a second direction and the first direction is perpendicular to the second direction. Each of the coaxial cables includes a conductor wire, an insulated layer covering the conductor wire, a shielding layer covering the insulated layer, and a coating layer covering the shielding layer. The soft-insulated cover covers peripheries of the coaxial cables arranged parallel.

In summary, based on one or some embodiments of the instant disclosure, the extension base with the flat cable and the flat cable are designed to make the cable thinner by configuring the cable into a flat shape. In some embodiments of the instant disclosure, the extension base with the flat cable and the flat cable use coaxial cables arranged parallel as the wire assembly inside the cable to increase data transmission speed. In some embodiments of the instant disclosure, the extension base with the flat cable and the flat cable use the soft-insulated cover to cover peripheries of the coaxial cables to improve the durability of the cable. Therefore, based on one or some embodiments of the instant disclosure, the thickness of the extension base can be reduced according to the extension base with the flat cable and the flat cable.

### BRIEF DESCRIPTION OF THE DRAWINGS

The disclosure will become more fully understood from the detailed description given herein below for illustration only, and thus not limitative of the disclosure, wherein:

FIG. 1 illustrates a schematic perspective view of the extension base with the flat cable according to an embodiment of the instant disclosure;

FIG. 2 illustrates a block diagram of the extension base with the flat cable according to an embodiment of the instant disclosure;

FIG. 3 illustrates a cross-sectional schematic view of the flat cable along line A-A in FIG. 1, according to an embodiment of the instant disclosure;

FIG. 4 illustrates a cross-sectional schematic view of the flat cable along line A-A in FIG. 1, according to another embodiment of the instant disclosure; and

FIG. 5 illustrates a cross-sectional schematic view of the flat cable along line A-A in FIG. 1, according to still another embodiment of the instant disclosure.

### DETAILED DESCRIPTION

It should be noted that the terms “first direction D1”, “second direction D2”, “third direction D3”, “width W”, “length L”, and “thickness H” are only for the convenience of description and simplified description of the instant disclosure, rather than indicating or suggesting that the device or element referred to must have a specific orientation, a specific orientation construction and length, and therefore cannot be understood as limitations to the instant disclosure. In addition, the terms “first” and “second” are used for descriptive purposes only and should not be interpreted as indicating or implying relative importance. The terms “first direction D1” and “second direction D2” are two different directions.

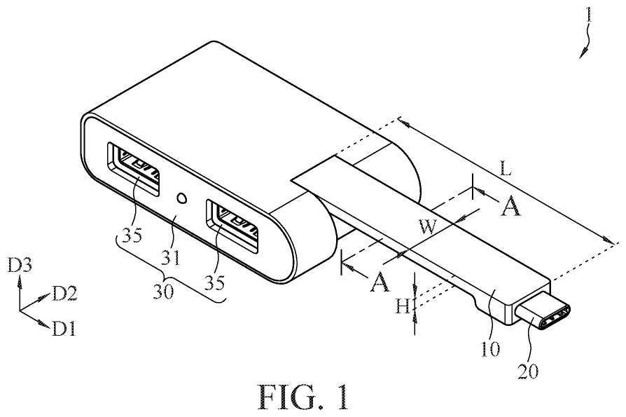

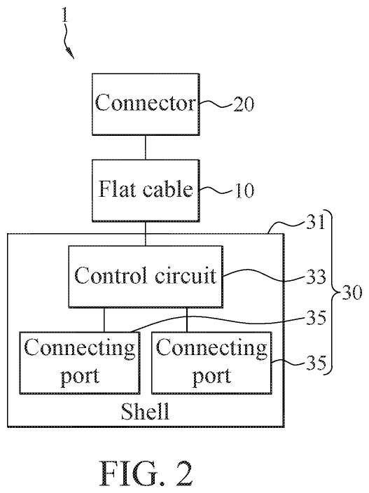

Please refer to FIG. 1 and FIG. 2. In some embodiments, an extension base 1 with flat cable 10 includes a base body 30, a flat cable 10, and a connector 20. The base body 30 includes a shell 31, a control circuit 33, and at least one connecting port 35. The control circuit 33 is inside the shell 31. The at least one connecting port 35 is coupled to the control circuit 33 and disposed on an outer wall of the shell 31. One of two ends of the flat cable 10 is connected to the base body 30, and the other end of the flat cable 10 is connected to the connector 20.

In this embodiment, the extension base 1 can transmit signals (e.g. data or commands) between the two devices. The control circuit 33 is coupled to the at least one connecting port 35, and is coupled to the connector 20 through the flat cable 10. In some embodiments, two external devices are coupled to each other via coupling to the extension base 1. In other words, one of the two external devices is coupled to the connector 20, and the other external device is coupled to the at least one port 35. The control circuit 33 can control the signal transmitted between the connector 20 and the at least one connecting port 35. In an exemplary embodiment, the connector 20 receives a signal inputted from an external device, and the signal received by the connector 20 is transmitted to the base body 30 via the flat cable 10, and is outputted to the other external device via the at least one connecting port 35 under the control of the control circuit 33. In another exemplary embodiment, a signal from an external device can also be inputted to the base body 30 via the connecting port 35, and the input signal is outputted by the connector 20 to the other external device via the transmission of the flat cable 10 under the control of the control circuit 33. For example, a computer and a universal serial bus (USB) device can transmit file data via the extension base 1, that is, the connector 20 of the extension base 1 is connected to a port of the computer, and the USB device is connected to the connecting port 35. Therefore, the data in the computer can be transmitted to the USB device for storage, or the data in the USB device can be transmitted to the computer.

In some embodiments, the connecting port 35 and the connector 20 are Input/Output ports (I/O ports). The connecting port 35 and the connector 20 may be hardware interfaces connected to external devices. In some embodiments, the number of the connecting port 35 of the base body 30 may be one, two, or more. In an exemplary embodiment, when the extension base 1 has plural connecting ports 35, the specification of each connecting port 35 can be the same or different. In other words, the extension base 1 can be provided with connecting ports 35 with different specifications according to the requirements. In some exemplary embodiments, the number of the connector 20 is one, and the signal transmission within the extension base 1 can be implemented in a one-to-one manner or a many-to-one manner.

For example, the specifications of the connecting port 35 may be, but is not limited to, FireWire (or called IEEE 1394), High Definition Multimedia Interface (HDMI), and USB (such as USB type-A, Micro-B, or USB type-C). The specifications of the connectors 20 may be, but is not limited to, FireWire (or IEEE 1394), High Definition Multimedia Interface (HDMI), and USB (such as USB type-A, Micro-B, or USB type-C).

In some embodiments, the shell 31 of the base body 30 includes an top surface, a bottom surface, and at least one side wall, and the top surface is connected to the bottom surface with the at least one side wall. The shell 31 may be, but is not limited to, cube-shaped or disc-shaped. For example, when the shell 31 is cube-shaped and is viewed from the top surface, the shell 31 includes four side walls, and each side wall is connected between the top surface and the bottom surface. In one embodiment, each side wall may be a planar wall. In some embodiments, some of the four sidewalls are curved walls and the remaining sidewalls are planar walls. In one embodiment, when the shell 31 is disc-shaped, the shell 31 has one side wall; the side wall is annular and is connected between the top surface and bottom surface. In some embodiments, the shell 31 further includes a storage groove, and the flat cable 10 can be accommodated in the storage groove. The storage groove may be arranged on the top surface, the bottom surface, the side wall or combinations thereof of shell 31. For example, when a connection position between the flat cable 10 and the base body 30 is on the top surface of the shell 31, the storage groove is arranged on the side wall adjacent to the connection position and the bottom surface. In other words, the flat cable 10 can be placed and stored in the storage groove along the side wall and the bottom surface. When the connection position of the flat cable 10 and the base body is on the side wall of the shell, the storage groove is arranged on the side wall. In other words, the flat cable 10 can be placed and stored in the storage groove along the side wall.

From the top view of the top surface of the shell 31, in some embodiments, the at least one connecting port 35 is arranged on the at least one side wall of the shell 31. For example, one side wall of the shell 31 may be provided with one, two, or more connecting ports 35; alternatively, different numbers of connecting ports 35 may be provided on each of the side walls of the shell 31.

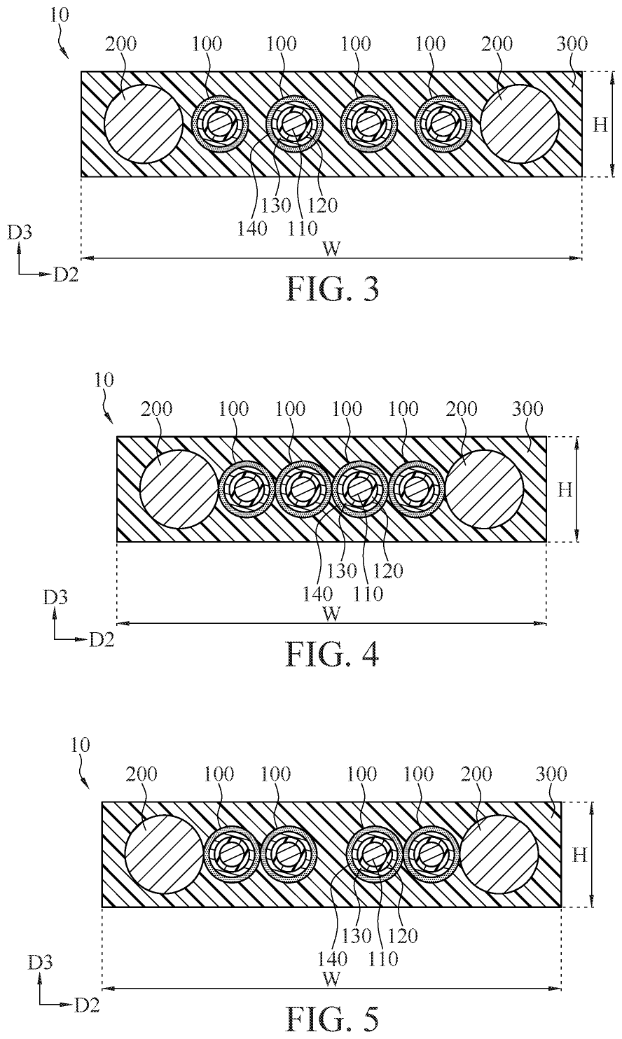

In this embodiment, the flat cable 10 may be a signal transmission line. Please refer to FIG. 3 to FIG. 5, FIG. 3 to FIG. 5 are cross-sectional schematic views of the flat cable taken along a line A-A in FIG. 1, wherein line A-A is a virtual transversal line extending along the second direction D2 and perpendicular to the first direction D1 and the third direction D3. The above “first direction D1”, “second direction D2′”, and “third direction D3” are perpendicular to each other, and the “first direction D1” is parallel to the long axis of the flat cable 10. In other words, the flat cable 10 includes a length L along the first direction D1, a width W along the second direction D2, and a thickness H along the third direction D3. In some embodiments, the length L, the width W, and the thickness H of the flat cable 10 can be adjusted according to the actual requirements of the extension base 1. For example, when the width W is greater than the thickness H, the outline of the flat cable 10 on the cross section along the line A-A may be elliptic or rectangular shape.

In some embodiments, the flat cable 10 includes a plurality of coaxial cables 100 and a soft-insulated cover 300. The soft-insulated cover 300 covers peripheries of the coaxial cables 100 arranged parallel. The coaxial cables 100 are wires arranged inside the flat cable 10. In some embodiments, the coaxial cables 100 are used for high-speed transmission (that is, the transmission speed is greater than or equal to 5 Gbps), and are coupled to the control circuit 33 and the connector 20 as signal transmission lines. In other embodiments, the coaxial cables 100 are coupled to the control circuit 33 as ground lines. The soft-insulated cover 300 has a protecting function for the internal arranged wire (i.e., the coaxial cables 100) of the flat cable 10 and an insulation function. Moreover, the above-mentioned “cover” is used to indicate that one substance is attached onto the surface of another substance. For example, the surface of the soft-insulated cover 300 directly contacts the outer peripheral surface of the coaxial cables 100, and no other interlayers exist between the soft-insulated cover 300 and the coaxial cables 100. That is, in this example, no shielding layer exists between the outside of the coaxial cables 100 and the inside of the soft-insulated cover 300.

In some embodiments, the coaxial cables 100 extend in the first direction D1 and are arranged in parallel in the second direction D2. In other words, the coaxial cables 100 are arranged parallel to each other. In some embodiments, one end of each of the coaxial cables 100 extending in the first direction D1 is coupled to the control circuit 33, and the other end of each of the coaxial cables 100 extending in the first direction D1 is coupled to the connector 20.

In some embodiments, referring to FIG. 3, the coaxial cables 100 are spacedly arranged. In other words, the axes of the coaxial cables 100 are parallel to each other and are arranged at a fixed distance from each other, and the outer peripheries of the coaxial cables 100 are not in contact with each other.

In other embodiments, when the width W of the flat cable 10 is adjusted to be thinner according to the appearance of the extension base 1, the coaxial cables 100 are closely arranged, so that a certain number of the coaxial cables 100 can be accommodated in the flat cable 10. Please refer to FIG. 4, the coaxial cables 100 are arranged and attached with each other side by side, that is, the axes of the coaxial cables 100 are parallel to each other, and the outer peripheries of the coaxial cables 100 are closely in contact with each other.

In still other embodiments, when the connector 20 connected to the flat cable 10 has a front and rear orientation insertion requirement (the requirement for dual insertion specification), the coaxial cables 100 can be grouped and arranged according to the requirements. Please refer to FIG. 5, the coaxial cables 100 are divided into a plurality of groups, wherein the coaxial cables 100 in a same group arranged and attached with each other side by side, and the coaxial cables 100 in different groups are spacedly arranged. For example, the coaxial cables 100 are divided into two groups, respectively corresponding to the front-orientation insertion and rear-orientation insertion, respectively.

The soft-insulated cover 300 is formed of a material relatively softer than the shell 31. In some embodiments, the soft-insulated cover 300 is formed of a rubber material that feels softer at room temperature. For example, the materials of the soft-insulated cover 300 may be silicone, thermoplastic elastomer (TPE), thermoplastic polyurethane (TPU), or polyvinylchloride (PVC).

In some embodiments, the soft-insulated cover 300 may be covered on the outer peripheries of the coaxial cables 100 by hot-pressing or injection molding. In some embodiments, when the material of the soft-insulated cover 300 is silicone, the soft-insulated cover 300 is covered on the outer peripheries of the coaxial cables 100 by ways of low-temperature output method.

Please refer to FIG. 1 and FIG. 3 to FIG. 5. In some embodiments, the soft-insulated cover 300 is the outermost layer of the flat cable 10. In other words, the outline of the soft-insulated cover 300 also has a width W along the second direction D2 and a thickness H along the third direction D3 on the cross section of the flat cable along the line A-A. In some embodiments, the width W is greater than the thickness H. For example, the outline of the soft-insulated cover 300 on the cross section along the line A-A may be elliptic or rectangular (not shown in figures).

In some embodiments, one of two ends of the flat cable 10 is connected to the upper surface of the base body 30, that is, in this embodiment, a portion of the soft-insulated cover 300 in contact with the upper surface of the base body 30 is connected to the shell 31, and the coaxial cables 100 are coupled to the control circuit 33. The other end of the flat cable 10 is coupled to the connector 20 with the coaxial cables 100.

In some embodiments, the flat cable 10 includes a plurality of electronic wires 200, and the electronic wires 200 are arranged parallel with the coaxial cables 100. One end of each of electronic wires 200 is coupled to control circuit 33, and the other end of each of the electronic wires 200 is coupled to the connector 20. Each of the electronic wires 200 is used for power transmission between the connector 20 and the control circuit 33. For example, when the connector 20 is connected to an electronic device (such as a computer or a portable charger), the power is transmitted to the control circuit 33 through the electronic wires 200. The control circuit 33 then outputs the power through the connecting port 35. Therefore, other electronic devices can have the power inputted though being connected to the connecting port 35. In some embodiments, the electronic wires 200 are single-core wires or multi-core wires.

Please refer to FIG. 3 to FIG. 5 again. In some embodiments, the axes of the electronic wires 200 are arranged parallel to the axes of the coaxial cables 100. Moreover, the electronic wires 200 are arranged at the outermost side of the coaxial cables 100, and are not attached with the coaxial cables 100 (as shown in FIG. 3). In other embodiments, the electronic wires 200 are arranged at the outermost side of the coaxial cables 100, and are attached with the coaxial cables 100 side by side (as shown in FIG. 4 and FIG. 5). Moreover, a diameter of each of the electronic wires 200 is greater than a diameter of each of the coaxial cables 100. The “diameter” refers to the diameter of a circular cross section area of the coaxial cable 100 and the electronic wire 200 along the third direction D3 perpendicular to the respective axes.

In some embodiments, the soft-insulated cover 300 may be directly attached to the outer peripheries of the electronic wires 200. In some embodiments, an internal surface of the soft-insulated cover 300 is directly attached the outer periphery of each of the electronic wires 200. In other words, when the electronic wires 200 and the coaxial cables 100 are attached and arranged closely together, the soft-insulated cover 300 covers other outer peripheral surfaces except the outer peripheral area where the coaxial cables 100 and the electronic wires 200 are attached with each other (as shown in FIG. 4 and FIG. 5). Therefore, no other interlayers exist between the soft-insulated cover 300 and the coaxial cables 100, or between the soft-insulated cover 300 and the electronic wires 200. On the contrary, when the electronic wires 200 are not attached with the coaxial cables 100 (that is, the electronic wires 200 are spacedly arranged with the coaxial cables 100), the soft-insulated cover 300 is filled in spaces between the coaxial cables 100 and the electronic wires 200, and covers the outer peripheries of the coaxial cable 100 and the outer peripheries of the electronic wires 200, respectively (as shown in FIG. 3). Therefore, no other interlayer exists between the soft-insulated cover 300 and the coaxial cables 100, or between the soft-insulated cover 300 and the electronic wires 200.

In this regard, the arrangement of the coaxial cable 100 and the electronic cable 200 in the flat cable 10 can be adjusted according to the width W, length L, and thickness H of the flat cable 10, or can be adjusted according to the connector 20 or the control circuit 33 of the extension base 1.

Please refer to FIG. 3 to FIG. 5 again. In some embodiments, each of the coaxial cables 100 includes a conductor wire 110, an insulated layer 120, a shielding layer 130, and a coating layer 140. Moreover, the insulated layer 120, the shielding layer 130, and the coating layer 140 sequentially cover the conductor wire 110 from the inside to the outside. In other words, the insulated layer 120 covers the conductor wire 110, the shielding layer 130 covers the insulated layer 120, and the coating layer 140 covers the shielding layer 130. The conductor wire 110 is used to transmit radio signals. The insulated layer 120 is used to isolate the conductor core wire 110 from the shielding layer 130. The shielding layer 130 is used to reduce the interference of surrounding metal objects on the signal transmission. Moreover, the shielding layer 130 may also be used for grounding. The coating layer 140 is used to protect the braided structure of the shielding layer 130 to reduce the possibility of the braided structure of the shielding layer 130 being scattered. In some embodiments, the material of the conductor wire 110 may be a copper core, and the material of the insulated layer 120 may be, but not limited to, polytetrafluoroethylene. The shielding layer 130 is a metal (for example, copper core, aluminum wire, aluminum foil, tin foil, or alloy) in braided configuration. The material of the coating layer 140 is an insulated material (for example, a plastic material, that is, polyvinyl chloride (PVC) or polyethylene (PE)).

Accordingly, the coaxial cables 100 are used as a wire assembly inside the flat cable 10 to improve the stability of signal transmission, the distance of signal transmission, and the durability of the flat cable 10. In other words, when the coaxial cables 100 are used as the wire assembly inside the flat cable 10, the number of times that the flat cable 10 can be bent and twisted can be increased.

In conclusion, according to some embodiments of the instant disclosure, the extension base 1 with the flat cable 100 and the flat cable 100 can meet the development trend in thinning trend the extension base 1 by configuring the flat cable 10 into a flat shape and can meet the usage requirements for the extension base 1 with the arrangement of the coaxial cables 100 inside the flat cable 10. Moreover, in some embodiments of the instant disclosure, when the coaxial cables 100 are used as the wire assembly, the durability and signal stability of the flat cables 10 can be improved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An extension base with flat cable, comprising:
a base body, comprising:
a shell;
a control circuit inside the shell; and
at least one connecting port coupled to the control circuit and disposed on an outer wall of the shell;
a flat cable, comprising:
a plurality of coaxial cables extending in a first direction and arranged parallel in a second direction, wherein the first direction is perpendicular to the second direction, and one of two ends of each of the coaxial cables is coupled to the control circuit; and
a soft-insulated cover covering peripheries of the coaxial cables arranged parallel; and
a connector, coupled to the other end of each of the coaxial cables.

2. The extension base with flat cable according to claim 1, wherein the flat cable further comprises:
a plurality of electronic wires arranged parallel with the coaxial cables, wherein a diameter of each of the electronic wires is greater than a diameter of each of the coaxial cables, wherein the soft-insulated cover further covers peripheries of the electronic wires.

3. The extension base with flat cable according to claim 2, wherein the soft-insulated cover has a width in the second direction and a thickness in a third direction, the third direction is perpendicular to the second direction, and the width is greater than the thickness.

4. The extension base with flat cable according to claim 2, wherein the soft-insulated cover is made of a material relatively softer than the shell.

5. The extension base with flat cable according to claim 1, wherein the soft-insulated cover has a width in the second direction and a thickness in a third direction, the third direction is perpendicular to the second direction, and the width is greater than the thickness.

6. The extension base with flat cable according to claim 1, wherein the coaxial cables are spacedly arranged.

7. The extension base with flat cable according to claim 1, wherein the coaxial cables are arranged and attached with each other side by side.

8. The extension base with flat cable according to claim 1, wherein the coaxial cables are divided into a plurality of groups, wherein the coaxial cables in a same group are arranged and attached with each other side by side, wherein the coaxial cables in different groups are spacedly arranged.

9. A flat cable, comprising:
a plurality of coaxial cables extending in a first direction and arranged parallel in a second direction, wherein the first direction is perpendicular to the second direction, each of the flat cables comprises:
a conductor wire;
an insulated layer covering the conductor wire;
a shielding layer covering the insulated layer; and
a coating layer covering the shielding layer; and
a soft-insulated cover, covering peripheries of the coaxial cables arranged parallel.

10. The flat cable according to claim 9, further comprising:
a plurality of electronic wires arranged parallel with the coaxial cables, wherein a diameter of each of the electronic wires is greater than a diameter of each of the coaxial cables, wherein the soft-insulated cover further covers peripheries of the electronic wires.

11. The flat cable according to claim 10, wherein the soft-insulated cover has a width in the second direction and a thickness in a third direction, the third direction is perpendicular to the second direction, and the width is greater than the thickness.

12. The flat cable according to claim 9, wherein the soft-insulated cover has a width in the second direction and a thickness in a third direction, the third direction is perpendicular to the second direction, and the width is greater than the thickness.

13. The flat cable according to claim 9, wherein the coaxial cables are spacedly arranged.

14. The flat cable according to claim 9, wherein the coaxial cables are arranged and attached with each other side by side.

15. The flat cable according to claim 9, wherein the coaxial cables are divided into a plurality of groups, wherein the coaxial cables in a same group arranged and attached with each other side by side, wherein the coaxial cables in different groups are spacedly arranged.
